(19) United States
(12) Patent Application Publication
(10) Pub. No.: US 2005/0204609 A1
(43) Pub. Date: Sep. 22, 2005

(54) Stabilizing downrigger weight with fish attracting means

(76) Inventor: Gerald G. Greene II, Monroe, MI (US)

Correspondence Address: Donald W. Meeker;Patent Agent, 924 East Ocean Front #E, Newport Beach, CA, 92661, US

(21) Appl. No.: 10/804,875

(22) Filed: Mar. 19, 2004

(51) Int. Cl. A01K 91/08

(52) U.S. Cl. 43/43.13

(57) ABSTRACT

A trolling weight body of heavy metal has two angled front faces and a flat bottom and flat top with a full length vertical top fin and extending vertical tail fin. Attaching the downrigger line to a hole in the top edge of the top fin noses the front down slightly to cause the top flat surface to act as a diving/planning force to maintain the trolling weight directly below the downrigger rod for a true depth reading on the downrigger line. Visual, auditory, and sensory stimulations to attract fish are provided by intersecting cross holes through the trolling weight body and a series of loose rings with colored beads dangling from a series of vertical holes along the back edge of the tail fin.

### BACKGROUND OF THE INVENTION

1. Field of the Invention

The present invention relates to downrigger or trolling weights and particularly to a trolling weight for use in big game fishing, which comprises a diving plane body made of heavy metal, intersecting passages through the body that create auditory stimulus, a stabilizing vertical fin, and rings with colored beads attached to holes in the stabilizing fin which create visual and auditory stimulus for attracting fish.

2. Description of the Prior Art

In troll fishing for big game fish, it is desirable to maintain one's lure or bait at a constant depth, and to be able to repeat this depth once it is determined how deep the fish are located. It is also desirable that the fishing line descend from the boat at a steep angle, to minimize line drag and the chances of entangling the line with obstacles, other lines, and the like. While at trolling depth, the trolling device should maintain depth independent of boat speed, and should be stable; that is, it should not veer from side to side or swing back away from the boat as downrigger balls tend to do thereby varying the actual depth of the fishing line and lure clipped to the trolling weight.

In big game fishing, normally the trolling weight is suspended in the water by a downrigger and cable system which indicates the length of cable which has been played out to determine the depth at which the trolling weight should be positioned. The trolling weight acts as a transporter of the fishing line and lure which is clipped to the rear of the trolling weight and lowered to the desired depth for fishing.

Normal downrigger balls swing back away from the boat when trolling thereby limiting a true reading of depth. There are charts published to adjust for downrigger ball swing, but that is inexact and dependent on the speed of the boat and current and requires too much effort to try and be precise about the depth.

Furthermore downrigger balls roll around in the boat, when not in use, potentially causing damage to the boat and equipment, injury to people onboard the boat, or loss of the balls overboard.

U.S. Pat. No. 4,486,970, issued Dec. 11, 1984 to Larson, shows a trolling depth controller having a body with a generally delta wing pattern and an air-foil cross section, the primary camber being on the lower surface and the nose being weighted. An upper fin includes a plurality of holes along its rearwardly sloping leading edge for attachment of the towing line. A lower, rearwardly sloped fin also includes a plurality of holes, at least some of which are positioned along a trailing edge for attachment of the towed lure or bait line.

U.S. Pat. No. 5,608,986, issued Mar. 11, 1997 to Spurgeon, concerns a trolling weight used in conjunction with downrigger type fishing systems, which is very stable and tracks straight at trolling speeds up to and greater than eight miles per hour. The weight is easily attached to any trolling cable using a variety of commercially available trolling cable attachment clips or by connecting the trolling cable directly to the trolling cable attachment eye of the trolling weight. The trolling weight varies in size ranging from two to sixty pounds with a broad selection of colors. The trolling weight is produced of materials considered to be environmentally safe to use in fisheries, unlike the lead weights now available. They are coated with a polyester powder coating and cured at approximately 400 degrees Fahrenheit to produce a hard abrasion resistive surface. The trolling weight's unique design is highly resistant to fouling when contacting underwater objects. Its fin is designed in that a handle is formed thereby providing a method by which the weight can be easily grasp for carrying and holding; therefore, reducing personal injury and equipment damage as a result of dropping. The trolling weight is of a single embodiment.

U.S. Pat. No. 6,018,903, issued Feb. 1, 2000 to Miralles, puts forth an apparatus for transporting a fishing line to a position under the surface of a body of water, which includes a diving plane slidably connected to a guide line. The plane can be tilted between two positions to move the diving plane up or down the guideline. A movable weight on the diving plane stabilizes the diving plane in the desired tilted position and increases the angle of tilt of the diving plane when the diving plane slides up the guideline.

U.S. Pat. No. 5,412,897, issued May 9, 1995 to Smith, illustrates a downrigger weight assembly and line release device. The downrigger weight assembly includes a casing having forward and rearward compartments and a middle compartment threadably and sealably attached at opposite ends to the forward and rearward compartments so as to tandemly arrange the respective compartments. The forward and rearward compartments have reversely tapered configurations and define respective front and rear hollow cavities. The middle compartment has a cylindrical configuration and defines a hollow central cavity. A cartridge for holding fish bait or attractant material is disposed in the front hollow cavity of the forward compartment. A weighted body is disposed in rear hollow cavity of the rearward compartment for providing ballast. A downrigger line release device includes a clamp mounted to a fishing line, a coupler mounted to a downrigger line, and a swivel connector pivotally interconnecting the clamp and coupler to one another. The coupler includes a flexible retainer element convertible from a rolled-up condition in which it slidably receives the downrigger line to an unrolled condition in which it releases therefrom in response to a predetermined force being applied to the retainer element so as to permit uncoupling of the fishing line from the downrigger line.

U.S. Pat. No. 5,148,623, issued Sep. 22, 1992 to Haskell, is for a down rigger weight that includes a body having oppositely disposed first and second surfaces. First and second weights are provided and each of the weights substantially overlies one of the surfaces and the weights are of substantially equal dimension and weight. A nut and bolt secures the weights to the body. At least a first eyelet is secured to and extends from the first weight. A locking system is operably associated with the first weight for preventing rotation thereof about the nut and bolt.

U.S. Pat. No. 6,453,600, issued Sep. 24, 2002 to Craig, describes a fishing planer, which may be used to troll a lure at a significant depth beneath the boat without the inconvenience of using an inordinate amount of weight. The fishing planer changes configuration to rise if a fish strikes the lure or if the lure becomes snagged and automatically changes back to diving configuration if the fish gets off or the lure is freed from the snag. The fishing planer also may be configured so that it may be trolled to either side of the boat away from the path of the boat.

U.S. Pat. No. 6,640,487, issued Nov. 4, 2003 to Angwin, claims a scent releasing fishing apparatus such as a downrigger weight. The apparatus includes a body having a cavity formed therein providing a reservoir to hold an amount of scented attractant in liquid form. A nozzle may be removably coupled with the body and in communication with the cavity for releasing the liquid material contained therein. A wicking member may be partially disposed in the cavity and extend through the nozzle orifice such that it is partially externally located relative to the body of the apparatus. The wicking member is formed of an absorbent material and assists in delivering the liquid material through the nozzle through a wicking or capillary action. The apparatus may be formed of a dense material such as lead for easy submersion in a body of water.

U.S. Pat. No. 5,918,408, issued Jul. 6, 1999 to Laney, indicates a diving fishing weight for receiving a length of fishing line with a first end connected to a fish catching device and a second end connected to a rod and reel assembly. The fishing weight includes a dive-inducing member constructed to dive through water, and dive-stop structure in communication with the dive-inducing member and the fishing line, and being actuable by a force exerted along the fishing line to stop the fishing weight from diving. The dive-inducing member includes a body that has a front region oriented generally toward the fish catching device, a rear region oriented generally toward the rod and reel assembly, opposed sides and an upper surface. The dive-stop structure includes a passage defined by the body that extends through at least a portion of the body, with the passage having a first end proximate the front region of the body and a second end on the upper surface. The fishing weight further includes a pair of wings connected to the body and extending in generally opposed directions outwardly and upwardly from the rear portion of the body toward the front portion and the upper surface to define a wing plane. The fishing weight has a center of gravity bounded generally by the wing plane, and the center of gravity and wing plane cooperate to predispose the weight to dive at a pre-determined angle. The fishing weight is also formed from a novel polymer-based composite material consisting essentially of a first volume of a curable polymeric component mixed with a second volume of iron ferrite particles, such that the unit has a specific gravity of about 7.5-8.0, with the unit including a central substantially uncured section and an outer substantially cured section.

U.S. Pat. No. 6,170,191, issued Jan. 9, 2001 to Laney, discloses a diving fishing weight for receiving a length of fishing line with a first end connected to a fish catching device and a second end connected to a rod and reel assembly. The fishing weight includes a dive-inducing member constructed to dive through water, and dive-stop structure in communication with the dive-inducing member and the fishing line, and being actuable by a force exerted along the fishing line to stop the fishing weight from diving. The dive-inducing member includes a body that has a front region oriented generally toward the fish catching device, a rear region oriented generally toward the rod and reel assembly, opposed sides and an upper surface. The dive-stop structure includes a passage defined by the body that extends through at least a portion of the body, with the passage having a first end proximate the front region of the body and a second end on the upper surface. The fishing weight further includes a pair of wings connected to the body and extending in generally opposed directions outwardly and upwardly from the rear portion of the body toward the front portion and the upper surface to define a wing plane. The fishing weight has a center of gravity bounded generally by the wing plane, and the center of gravity and wing plane cooperate to predispose the weight to dive at a pre-determined angle. The fishing weight is also formed from a novel polymer-based composite material consisting essentially of a first volume of a curable polymeric component mixed with a second volume of iron ferrite particles, such that the unit has a specific gravity of about 7.5-8.0, with the unit including a central substantially uncured section and an outer substantially cured section.

U.S. Patent Application No. 20010032412, published Oct. 25, 2001 by Laney, discloses a diving fishing weight for receiving a length of fishing line with a first end connected to a fish catching device and a second end connected to a rod and reel assembly. The fishing weight includes a dive-inducing member constructed to dive through water, and dive-stop structure in communication with the dive-inducing member and the fishing line, and being actuable by a force exerted along the fishing line to stop the fishing weight from diving. The dive-inducing member includes a body that has a front region oriented generally toward the fish catching device, a rear region oriented generally toward the rod and reel assembly, opposed sides and an upper surface. The dive-stop structure includes a passage defined by the body that extends through at least a portion of the body, with the passage having a first end proximate the front region of the body and a second end on the upper surface. The fishing weight further includes a pair of wings connected to the body and extending in generally opposed directions outwardly and upwardly from the rear portion of the body toward the front portion and the upper surface to define a wing plane. The fishing weight has a center of gravity bounded generally by the wing plane, and the center of gravity and wing plane cooperate to predispose the weight to dive at a pre-determined angle. The fishing weight is also formed from a novel polymer-based composite material consisting essentially of a first volume of a curable polymeric component mixed with a second volume of iron ferrite particles, such that the unit has a specific gravity of about 7.5-8.0, with the unit including a central substantially uncured section and an outer substantially cured section.

U.S. Pat. No. D284,686, issued Jul. 15, 1986 to Hudson, provides the ornamental design for a fishing troll weight.

U.S. Pat. No. D243,177, issued Jan. 25, 1977 to Kammeraad, shows the ornamental design for a trolling weight, which has a stabilizing fin.

U.S. Pat. No. D340,107, issued Oct. 5, 1993 to Weber, claims the ornamental design for a trolling sinker.

U.S. Pat. No. 5,018,296, issued May 28, 1991 to Putz, II, provides a trolling device for fishing at a desired depth. The device comprises a plate-like hydrofoil member having a leading edge and a trailing edge, a first strut extending upwardly from the hydrofoil member, the strut having an opening or other securing device for securing it to the end of a downrigger line to tow the device behind a boat. A releasable fastening device is secured to the trolling device for releasably securing it to an intermediate position on a fishing line. A weighted keel assembly depends downwardly from the hydrofoil member to direct it downwardly at its leading edge into a diving position when the device is suspended from the towing or downrigger line of a boat.

U.S. Pat. No. 3,842,528, issued Oct. 22, 1974 to Hish, describes sinker weights for fishing lines that include a solid body with an affixed tail assembly having apertures formed therein. Additionally, the tail assembly may also include tabs associated with the apertures and these tabs may also include apertures therein. The body is designed to present a pointed forward edge in horizontal section as the weight is towed during a trolling operation. These weights are not subject to substantial pivoting or rotation during motion through water and are designed to move smoothly through the water with minimal resistance. Furthermore, the weights produce vibration induced sound waves, which attract fish.

U.S. Pat. No. 2,891,345, issued Jun. 23, 1959 to Uhlen, discloses a fishing line submerger, which comprises a plate bent along its longitudinal middle plane providing a pair of symmetrical planes extending at an obtuse angle relative to one another, said plate having a longitudinally extending slot in one end portion thereof. The submerger further comprises a channel member connected to the plate beneath and in communication with the slot, a weight connected to the channel member, a rack slidably mounted in said channel member and a fishing line connector carried by the rack and extending through the slot. The submerger also comprises an angle lever pivotally connected to the plate with one arm forming a pawl for engaging the rack and the other arm extending from the plate for being connected to a bait line. Resilient means are provided to retain the pawl in engagement with the rack for retaining said rack at various positions relative to the channel member until released by a pull on the bait line, whereupon the fishing line pulls the rack to the weighted end of said plate, indicating such action to the user and causing the surfacing of the submerger.

U.S. Pat. No. 2,843,966, issued Jul. 22, 1958 to Ingram, indicates a depth regulator for a fishing lure. The depth regulator comprises a vertical fin, a float on the upper portion of said fin, a stabilizing vane transversely secured to the lower portion of said fin, means adapted to facilitate the attachment of the lure to the rear edge of the fin, and means adapted to facilitate the attachment of a trolling line to the forward edge of the fin.

U.S. Pat. No. 2,924,907, issued Feb. 16, 1960 to Hamilton, puts forth a fishing line stabilizer and directional control device, which is adapted to be pulled through the water on a fishing line. The device comprises a body that has apertures around the entire periphery of its stabilizing fin and wings that create an audible fish attractant when pulled through the water.

What is needed is a trolling weight with dynamic properties which maintain the weight at the desired depth directly below the boat.

### SUMMARY OF THE INVENTION

An object of the present invention is to provide a trolling weight with having hydrodynamic properties which maintain the weight and the line and lure at the desired depth directly below the boat on a measured length of cable.

A related object of the present invention is to provide a flat top surface on the trolling weight which along with a downrigger cable attachment hole positioned with the “hang point” of the weight just behind the center of gravity so the weight hangs down from the “downrigger” rod at a 2-5% nose down attitude when pulled through the water during trolling so that the flat top surface acts as a diving/planning force to help maintain the weight running at true depth directly below the downrigger rod on the boat and prevent swing back.

Another object of the present invention is to provide tapered front faces on the trolling weight so that it cuts through the water more effectively.

One more object of the present invention is to provide a full length vertical fin along the top of the trolling weight body and vertical tail fin extending out the back of the trolling weight body for greater stability when trolling at slow or fast speeds.

An additional object of the present invention is to provide a flat bottom on the trolling weight so that it will not roll around when stored in the boat.

A further object of the present invention is to provide intersecting cross drilled holes through the body of the trolling weight each one drilled from a tapered front face to an opposite side to allow water passage through the trolling weight body that creates turbulence, vibration, and sound waves to attract fish.

A contributory object of the present invention is to provide a series of metal rings with colored beads attached to a series of holes in the back edge of the vertical tail fin which move around when the trolling weight is in motion to create sound, vibration, and color as further attracting agents for the game fish.

An added object of the present invention is to provide a trolling weight that is lighter in weight but more effective than the heavier downrigger balls due to the effective hydrodynamic behavior of the structural features of the trolling weight of the present invention.

An ensuing object of the present invention is to provide a trolling weight with many effective hydrodynamic features, but which nevertheless can be manufactured easily in a one-piece casting in steel, cast iron, brass, or bronze alloy, or in a two-piece assembly with the steel fin and steel body made separately and assembled by welding, brazing, or some other means of joining the two pieces together with the fin fitted into a groove in the trolling weight body.

In brief, a trolling weight body of heavy metal has two angled front faces and a flat bottom and flat top with a full length vertical top fin and extending vertical tail fin. Attaching the downrigger line to a hole in the top edge of the top fin noses the front down slightly to cause the top flat surface to act as a diving/planning force to maintain the trolling weight directly below the downrigger rod for a true depth reading on the downrigger line.

Angled back front faces of the trolling weight body help the weight to cut through the water more effectively and the fins assist in maintaining a straight course.

Visual, auditory, and sensory stimulations to attract fish are provided by intersecting cross holes through the trolling weight body and a series of loose rings with colored beads dangling from a series of vertical holes along the back edge of the tail fin.

An advantage of the present invention is that the trolling weight maintains the line and lure at the desired depth directly below the boat on a measured length of downrigger cable.

A related advantage of the present invention is that it acts as a diving/planning force to help maintain the weight running at true depth directly below the downrigger rod on the boat.

Another advantage of the present invention is that it cuts through the water more effectively.

One more advantage of the present invention is that it has greater stability when trolling at slow or fast speeds.

An additional advantage of the present invention is that it will not roll around when stored in the boat.

A further advantage of the present invention is that it creates turbulence, vibration, sound waves, and color to attract game fish.

An added advantage of the present invention is that is lighter in weight but more effective than the heavier downrigger balls.

An ensuing advantage of the present invention is that it has many effective hydrodynamic features, but can be manufactured easily in a one-piece casting or in a two-piece assembly.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the trolling weight of the present invention attached to a downrigger line;

FIG. 2 is a perspective view of the trolling weight of the present invention showing the vertical top fin and vertical tail fin inserted in grooves in the trolling weight body as a two-piece assembly and showing the drilled cross holes through the trolling weight body;

FIG. 3 is a side elevational view of a big game fishing boat with the trolling weight shown below the boat at a different scale from the boat and showing the line and lure clipped to the trolling weight;

FIG. 4 is a top plan view of a big game fishing boat with the trolling weight of FIG. 3.

### BEST MODE FOR CARRYING OUT THE INVENTION

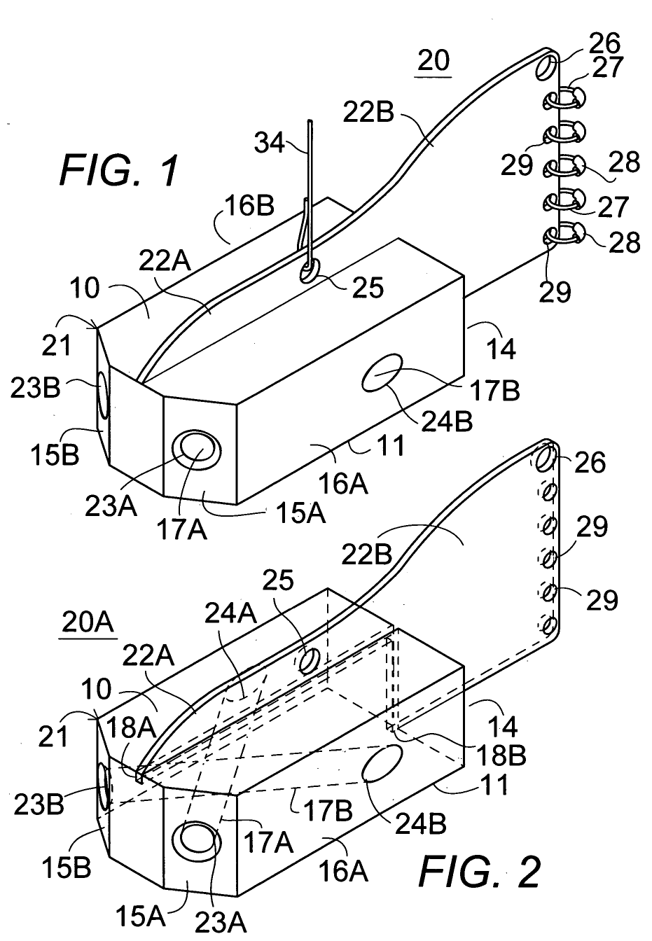

In FIGS. 1-4, a trolling weight device 20 comprises a trolling weight body 21 comprising a heavy block having a flat top planing surface 10, a flat bottom resting surface 11 (to prevent movement when the device is stored in the boat), and two angled front faces 15A and 15B adapted for cutting through the water with a full length vertical top fin 22A protruding from the top planing surface 10 of the trolling weight body 21 and a vertical tail fin 22B extending from a back face of the trolling weight body. The vertical fins provide greater stability when trolling.

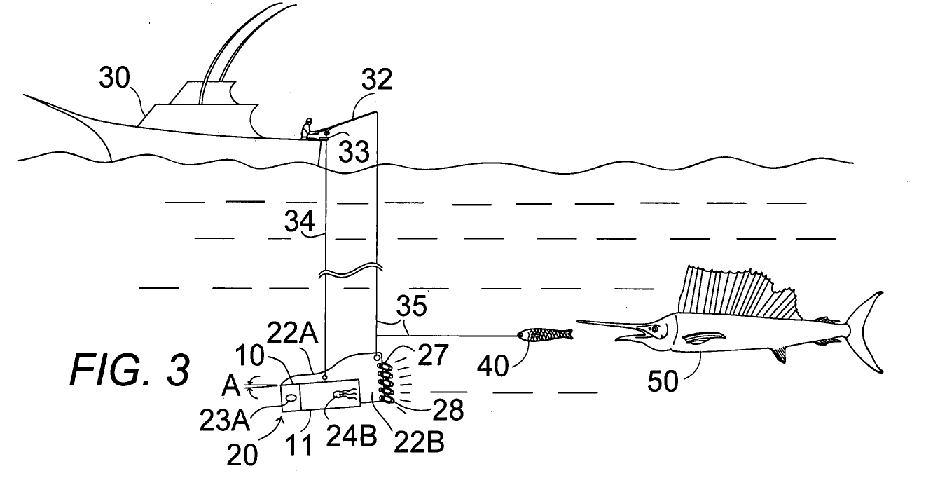

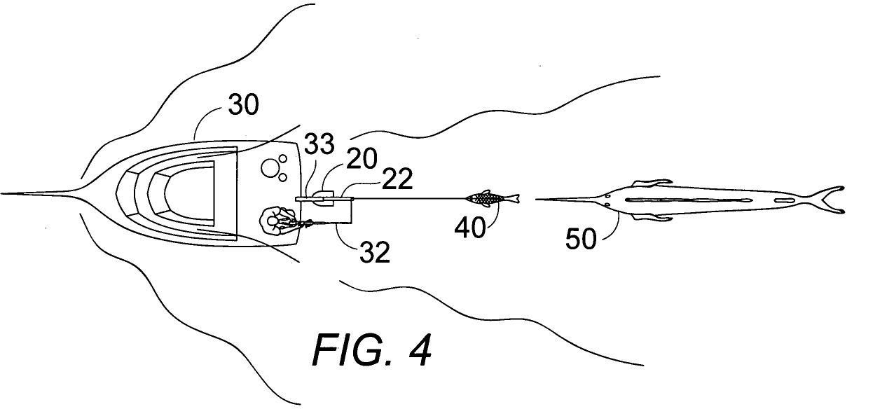

The top fin 22A has a downrigger line hole 25 therethrough adjacent to a top edge of the top fin at a point behind a center of gravity of the trolling weight body for receiving a downrigger line 34 from a boat engaged in the hole so that the top planing surface 10 is angled downwardly toward a front of the trolling weight body at an angle A of 2% to 5% from the horizontal, as seen in FIG. 3, so that the top flat surface 10 is adapted to act as a diving/planing surface to maintain the trolling weight directly below the downrigger rod 33 for a true depth reading on a downrigger line 34. The tail fin 22B has a fishing line hole 26 therethrough adjacent to a top rear edge of the tail fin, the hole adapted for receiving a fishing line 35 removably clipped to the fishing line hole, as seen in FIG. 3.

In FIGS. 1 and 2, the trolling weight body 21 further comprises a pair of intersecting cross tunnels 17A and 17B drilled through the trolling weight body, each of the cross tunnels running from an opening 23A and 23B in one of the angled front faces 15A and 15B to an opening 24A and 24B in an opposite side 16B and 16A, respectively, of the trolling weight body 21. The pair of intersecting cross tunnels 17A and 17B are adapted for allowing water passage through the trolling weight body to create turbulence, vibration, and sound waves to attract fish, as indicated by the wavy lines exiting the side opening 24B in FIG. 3.

In FIGS. 1 and 2, the tail fin 22B further comprises a series of ring holes 29 therethrough adjacent to a back edge of the tail fin 22B and the device further comprises a series of metal rings 27 with colored beads 28 attached to the tail fin 22B through the ring holes 29. The metal rings 27 are adapted for moving around when the trolling weight device 20 and 20A is in motion, the rings contacting each other and the tail fin to create sound, vibration, and color as attracting agents for game fish, as indicated by the wavy lines behind the rings 27 in FIG. 3.

In FIG. 1, the trolling weight body 21 and fins 22A and 22B of the device 20 are fabricated together in a one-piece casting.

In FIG. 2, the device 20A is made in a two-piece assembly with the top fin 22A and tail fin 22B formed as a single piece and the trolling weight body 2i formed separately with a horizontal slot 18A along the top planing surface 10 and a vertical slot 18B along a back vertical surface 14, the fin 22A and 22B is inserted in the slots and attached thereto preferably by welding or brazing.

The device 20 and 20A is preferably made from a metal selected from the list of metals including steel, cast iron, brass and bronze alloy.

In use, in FIGS. 3 and 4, the device 20 is lowered from a downrigger rod 33 at the back of the boat 30 by a downrigger cable 34 played out a measured length for an exact depth positioning as the device 20 hangs straight down with cable 34 attached through the downrigger line hole 25 in the top fin 22A, which downrigger line hole 25 is located at a point behind a center of gravity of the trolling weight body so that the top planing surface 10 is angled downwardly toward a front of the trolling weight body at an angle A of 2% to 5% from the horizontal, as seen in FIG. 3, so that the top flat surface 10 is adapted to act as a diving/planing surface to maintain the trolling weight directly below the downrigger rod 33 for a true depth reading on a downrigger line 34. The top fin 22A and tail fin 22B and front angled faces 15A and 15B further stabilize the device 20 in motion to prevent side sway and keep the device 20 directly below the boat 30. Because of the hydrodynamic stabilizing effects of these elements to maintain the device 20 directly below the boat for a true downrigger cable depth reading, the device 20 can be much lighter in weight than downrigger balls.

The fishing line 35, with a hook and lure or bait fish 40, is removably clipped to the fishing line hole 26 at the top back portion of the tail fin 22B, as seen in FIG. 3.

The pair of intersecting cross tunnels 17A and 17B allow water passage through the trolling weight body to create turbulence, vibration, and sound waves to attract game fish 50, as indicated by the wavy lines exiting the side opening 24B in FIG. 3.

The metal rings 27 with the beads 28 contact each other and the tail fin 22B to create sound, vibration, and color as attracting agents for game fish 50, as indicated by the wavy lines behind the rings 27 in FIG. 3.

It is understood that the preceding description is given merely by way of illustration and not in limitation of the invention and that various modifications may be made thereto without departing from the spirit of the invention as claimed.

1. A trolling weight device comprising:
a trolling weight body comprising a heavy block having a flat top planing surface, a flat bottom resting surface, and two angled front faces adapted for cutting through the water;
a full length vertical top fin protruding from the top planing surface of the trolling weight body and a vertical tail fin extending from a back face of the trolling weight body, the vertical fins adapted for providing greater stability when trolling, the top fin having a downrigger line hole therethrough adjacent to a top edge of the top fin at a point behind a center of gravity of the trolling weight body, the downrigger line hole adapted for receiving a downrigger line from a boat engaged in the hole so that the top planing surface is angled downwardly toward a front of the trolling weight body so that the top flat surface is adapted to act as a diving/planing surface to maintain the trolling weight directly below the downrigger rod for a true depth reading on a downrigger line, the tail fin having a fishing line hole therethrough adjacent to a top rear edge of the tail fin, the hole adapted for receiving a fishing line removably clipped to the fishing line hole.

2. The device of claim 1 wherein the trolling weight body further comprises a pair of intersecting cross tunnels through the trolling weight body, each of the cross tunnels running from one of the angled front faces to an opposite side of the trolling weight body, the pair of intersecting cross tunnels adapted for allowing water passage through the trolling weight body to create turbulence, vibration, and sound waves to attract fish.

3. The device of claim 1 wherein the tail fin further comprises a series of ring-holes therethrough adjacent to a back edge of the tail fin, and the device further comprises a series of metal rings with colored beads attached to the tail fin through the ring holes, the metal rings adapted for moving around when the trolling weight device is in motion, the rings contacting each other and the tail fin to create sound, vibration, and color as attracting agents for game fish.

4. The device of claim 1 wherein the trolling weight body and fins are fabricated together in a one-piece casting.

5. The device of claim 4 wherein the device is made from a metal selected from the list of metals including steel, cast iron, brass and bronze alloy.

6. The device of claim 4 wherein the device is made in a two-piece assembly with the top fin and tail fin formed as a single piece and the trolling weight body formed separately with a horizontal slot along the top planing surface and a vertical slot along a back vertical surface, the fin being inserted in the slots and attached thereto.

7. The device of claim 6 wherein the fin is attached to the body by welding.

8. The device of claim 6 wherein the fin is attached to the body by brazing.
